(19) United States
(12) Patent Application Publication
(10) Pub. No.: US 2026/0366667 A1
(43) Pub. Date: Nov. 19, 2026

(54) PIPELINE PIG CATCHER

(71) Applicant: Anti-Pollution Innovations, LP, McKinney, TX (US)

(72) Inventors: Darrel B. Fruit, Oklahoma City, OK (US); Jack G. Brewer, Chickasha, OK (US); John C. Kelsey, Stillwater, OK (US)

(21) Appl. No.: 19/752,267

(22) Filed: Jul. 23, 2026

Related U.S. Application Data
(63) Continuation of application No. 18/197,313, filed on May 15, 2023, now Pat. No. 12,710,124.

(51) Int. Cl. F16L 55/46

(52) U.S. Cl. CPC F16L 55/46

(57) ABSTRACT

An apparatus and process used to catch a pipeline pig after use in a pipeline. The process involves placing the pig catcher apparatus adjacent the catcher station of a pipeline, such that a pipeline pig coming out of the catcher station lands on a metal screen of the pig catcher apparatus. The pig catcher apparatus includes a vessel with a double wall configuration, a metal screen extending across an upper aperture such that the pipeline pig can be supported on the metal screen and fluids and small particulate matter can pass through the screen into the center chamber, a lid configured to cover the upper aperture, and a plurality of feet integrally molded with the outer wall. The feet are located along the outer edge so as to extend outwardly therefrom and are spaced apart.

### CROSS REFERENCE TO RELATED APPLICATION

This application is a continuation of United States Application Serial No. 18/197,313 filed on May 15, 2023, now allowed, which is hereby incorporated by reference.

### FIELD OF THE INVENTION

The present disclosure relates to pipelines, for example, pipelines for transmitting fluids such as hydrocarbons. More specifically, this disclosure relates to devices and methods for catching or trapping a pig after use in a pipeline.

### BACKGROUND OF THE INVENTION

Pipelines that carry fluids, for example, petroleum, natural gas, multi-phase fluids or other fluids, are internally inspected or cleaned by inserting a pig into the pipeline at a first point. The fluids flowing through the pipeline push the pig through the pipeline to a second point where the pig is removed from the pipeline or caught.

A pipeline pig can be any structure or device that can move through a pipeline to perform a function. For example, a pipeline pig can be implemented as a pipeline scraper to clean an interior of the pipeline. In another example, a pipeline pig can be implemented to swab, i.e., remove liquids or gases, from the pipeline. In a further example, a pipeline pig can be implemented to batch, i.e., separate different fluids in the pipeline. In additional examples, pipeline pigs can be implemented to perform intelligent operations such as monitoring and conveying information about a particular condition or performance of the pipeline.

Pipeline pigs can be launched into pipelines by providing launch stations or catcher stations (or both) at multiple points along the pipeline at which a pipeline pig will be inserted or removed (or both).

### SUMMARY OF THE INVENTION

This disclosure primarily concerns catcher stations, pig-catcher apparatus, and processes for receiving or retaining pipeline pigs discharged from a pipeline catcher station. In various embodiments, a pig catcher apparatus is positioned adjacent a pipeline catcher station such that a discharged pipeline pig lands, is received by, and/or is retained on a metal screen of the pig catcher apparatus, wherein the pig catcher apparatus comprises a vessel having a double wall configuration, wherein the vessel includes an inner wall and an outer wall, a lid, and a metal screen.

In some non-limiting embodiments, a process for catching a pipeline pig after use in a pipeline having a catcher station from which a pipeline pig comes out of a pipeline, the process comprising placing a pig catcher apparatus adjacent to the catcher station of a pipeline such that the pipeline pig coming out of the catcher station lands on the pig catcher apparatus. The pig catcher apparatus comprising a vessel having a double wall configuration including an inner wall having an inner bottom portion and an inner closed-wall portion extending upward from the inner bottom portion so as to define a center chamber terminating in an upper aperture; and an outer wall having an outer bottom portion and an outer closed-wall portion extending upward from the outer bottom portion, wherein the outer bottom portion is flat, and the outer bottom potion and the outer closed-wall portion meet at an outer edge; and wherein the inner wall and outer wall are configured so as to define an enclosed gap-chamber such that the gap-chamber surrounds at least the inner bottom portion and inner closed-wall portion; the pig catcher apparatus comprising a metal screen extending across the upper aperture such that the pipeline pig can be supported on the metal screen and fluids and small particulate matter can pass through the screen into the center chamber; and a plurality of feet integrally molded with the outer wall, wherein the plurality of feet are located along the outer edge of the outer wall so as to extend outwardly therefrom and are spaced apart. The process comprising burying at least a portion of the vessel such that the plurality of feet are secured by dirt and/or concrete; catching the pipeline pig coming out of the catcher station on the metal screen of the pig catcher apparatus; and allowing fluids and small particulate matter to pass through the metal screen into the center chamber.

In some non-limiting embodiments, the process is further comprising cleaning out the center chamber using a vacuum hose after the step of allowing fluids and small particles to pass through the screen, wherein the metal screen defines a clean-out aperture configured to allow the introduction of the vacuum hose into the center chamber.

In some non-limiting embodiments, the process is further comprising the outer wall and inner wall of the vessel of the pig catcher apparatus to be made from an anti-static plastic.

In some non-limiting embodiments, the process is further comprising grounding the pig catcher vessel and/or lid.

In some non-limiting embodiments, the pig catcher apparatus of the process further comprises at least a portion of the plurality of feet having a notch, and wherein the placing the pig catcher apparatus adjacent to the catcher station comprises driving a plurality of bars horizontally into the ground so that the each of the bars is received in a corresponding one of the notches such that rotation and horizontal movement of the pig catcher vessel is prevented.

In some embodiments, the pig catcher apparatus of the process further comprises a lid configured to cover the upper aperture, wherein the lid has an upper surface defining at least two V-drains; a swivel hinge mounted on the outer wall of the vessel, wherein the swivel hinge connects the lid to the vessel; and a latch mounted on the outer wall of the vessel so as to oppose the hinge.

In some non-limiting embodiments, a process for catching a pipeline pig after use in a pipeline having a catcher station from which a pipeline pig comes out of a pipeline, the process comprising placing a pig catcher apparatus adjacent to the catcher station of a pipeline such that a pipeline pig coming out of the catcher station lands on the pig catcher apparatus, the pig catcher apparatus comprising a double wall configuration including an inner wall having an inner bottom portion and an inner closed-wall portion extending upward from the inner bottom portion so as to define a center chamber terminating in an upper aperture; and an outer wall having an outer bottom portion and an outer closed-wall portion extending upward from the outer bottom portion, wherein the outer bottom portion is flat, and the outer bottom potion and the outer closed-wall portion meet at an outer edge, wherein the inner wall and outer wall are configured so as to define an enclosed gap-chamber such that the gap-chamber surrounds at least the inner bottom portion and inner closed-wall portion; and a metal screen extending across the upper aperture such that the pipeline pig can be supported on the metal screen and fluids and small particulate matter can pass through the screen into the center chamber; and a plurality of feet integrally molded with the outer wall, wherein the plurality of feet are located along the outer edge so as to extend outwardly therefrom and are spaced apart, wherein at least a portion of the plurality of feet have a notch, wherein placing the pig catcher apparatus adjacent to the catcher station further comprises driving a plurality of bars horizontally into the ground such that the each of the bars is received in a corresponding one of the notches such that rotation and horizontal movement of the pig catcher vessel is prevented; catching the pipeline pig coming out of the catcher station on the metal screen of the pig catcher apparatus; and allowing fluids and small particulate matter to pass through the metal screen into the center chamber.

In some non-limiting embodiments, the process further comprises cleaning out the center chamber using one or more vacuum hoses after the step of allowing fluids and small particles to pass through the metal screen, wherein the metal screen defines a clean-out aperture configured to allow the introduction of the one or more vacuum hoses into the center chamber.

In some non-limiting embodiments, the process further comprises the placing of the pig catcher apparatus adjacent to the catcher station comprising burying at least a portion of the pig catcher vessel such that the feet are secured by dirt and/or concrete.

In some non-limiting embodiments, wherein the outer wall and inner wall of the pig catcher apparatus of the process are made from an anti-static plastic.

In some non-limiting embodiments, the process further comprises grounding the pig catcher apparatus.

In some non-limiting embodiments, the pig catcher apparatus of the process further comprises a lid configured to cover the upper aperture of the vessel, wherein the lid has an upper surface defining at least two V-drains; a swivel hinge mounted on the outer wall of the vessel, wherein the swivel hinge connects the lid to the vessel; and a latch mounted on the outer wall of the vessel so as to oppose the hinge.

In some non-limiting embodiments, a pig catcher apparatus for receiving a pipeline pig after use in a pipeline comprises a vessel having a double wall configuration including an inner wall having an inner bottom portion and an inner closed-wall portion extending upward from the inner bottom portion so as to define a center chamber terminating in an upper aperture; and an outer wall having an outer bottom portion and an outer closed-wall portion extending upward from the outer bottom portion, wherein the outer bottom portion is flat, and the outer bottom potion and the outer closed-wall portion meet at an outer edge, wherein the inner wall and outer wall are configured so as to define an enclosed gap-chamber such that the gap-chamber surrounds at least the inner bottom portion and inner closed-wall portion; a metal screen extending across the upper aperture such that the pipeline pig can be supported on the metal screen and fluids and small particulate matter can pass through the screen into the center chamber, wherein the metal screen defines a clean out aperture configured to allow the introduction of one or more hoses and used to clean out the center chamber; and a plurality of feet integrally molded with the outer wall, wherein the plurality of feet are located along the outer edge so as to extend outwardly therefrom and are spaced apart, wherein at least a portion of the plurality of feet have a notch therein configured to receive a bar so as to prevent rotation and horizontal movement of the pig catcher vessel of the pig catcher apparatus.

In some non-limiting embodiments, the outer wall and inner wall of the pig catcher apparatus are made from an anti-static plastic.

In some non-limiting embodiments, the pig catcher apparatus is grounded.

In some non-limiting embodiments, the pig catcher apparatus further comprises a lid configured to cover the upper aperture, wherein the lid has an upper surface defining at least two V-drains; a swivel hinge mounted on the outer wall of the vessel, wherein the swivel hinge connects the lid to the vessel; and a latch mounted on the outer wall of the vessel so as to oppose the hinge.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a top rear perspective view of an embodiment of the disclosed pig catcher apparatus.

FIG. 2 is a bottom front perspective view of the embodiment of FIG. 1.

FIG. 3 is a front view of the embodiment of FIG. 1.

FIG. 4 is a rear view of the embodiment of FIG. 1.

FIG. 5 is a cross-sectional view of an embodiment of the disclosure.

FIG. 6 is a perspective view of an embodiment with the lid open.

### DESCRIPTION OF EXEMPLARY EMBODIMENTS

The present disclosure may be understood more readily by reference to this detailed description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures and components have not been described in detail so as not to obscure the related relevant feature being described. Also, the description is not to be considered as limiting the scope of the embodiments described herein.

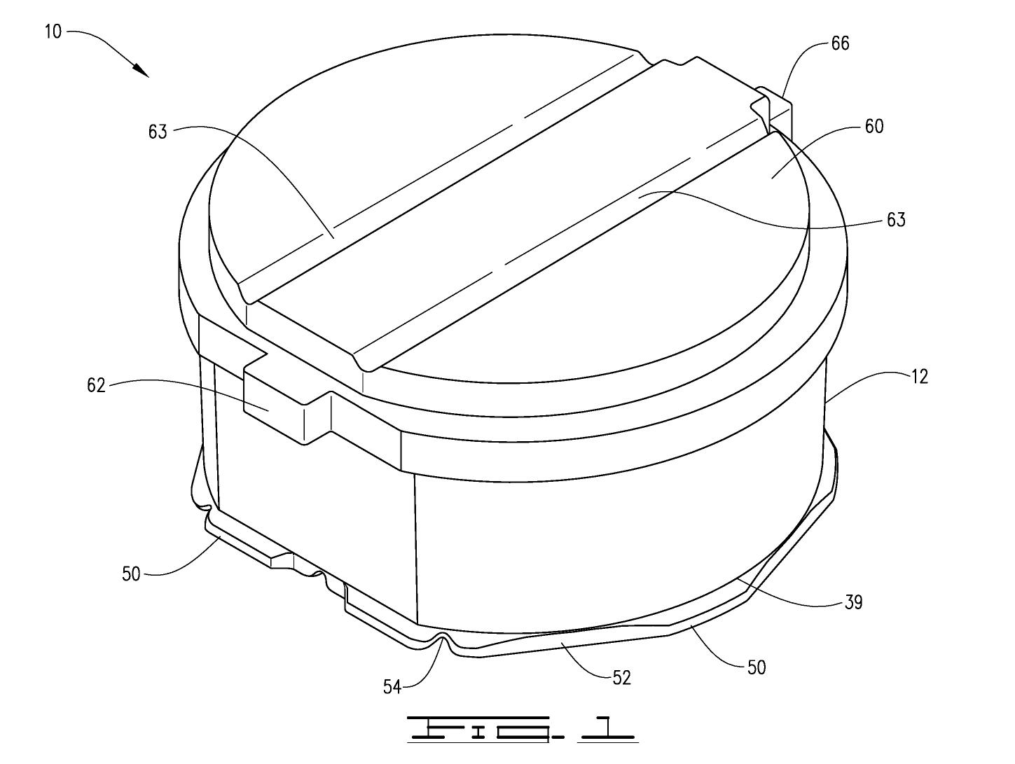

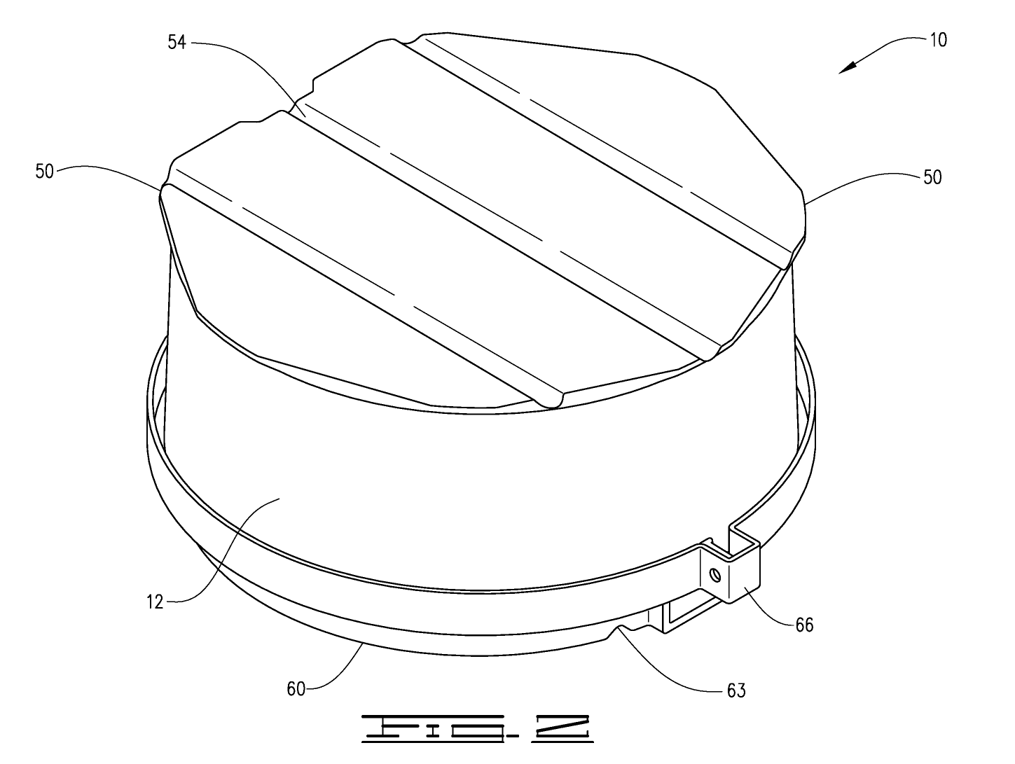

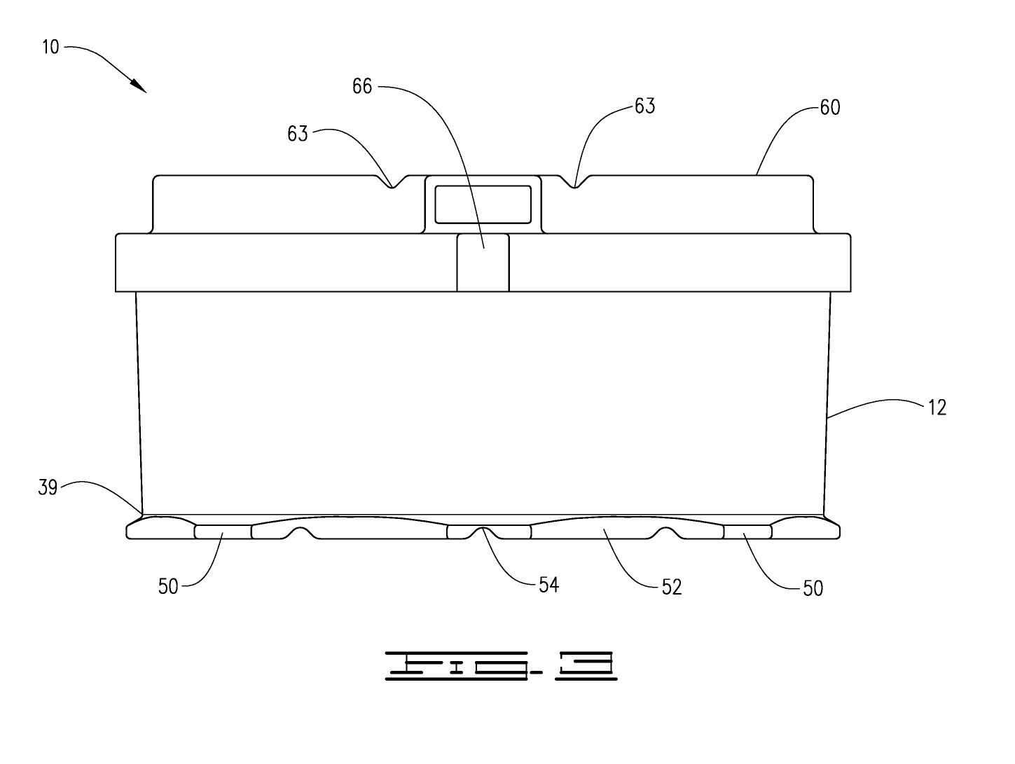

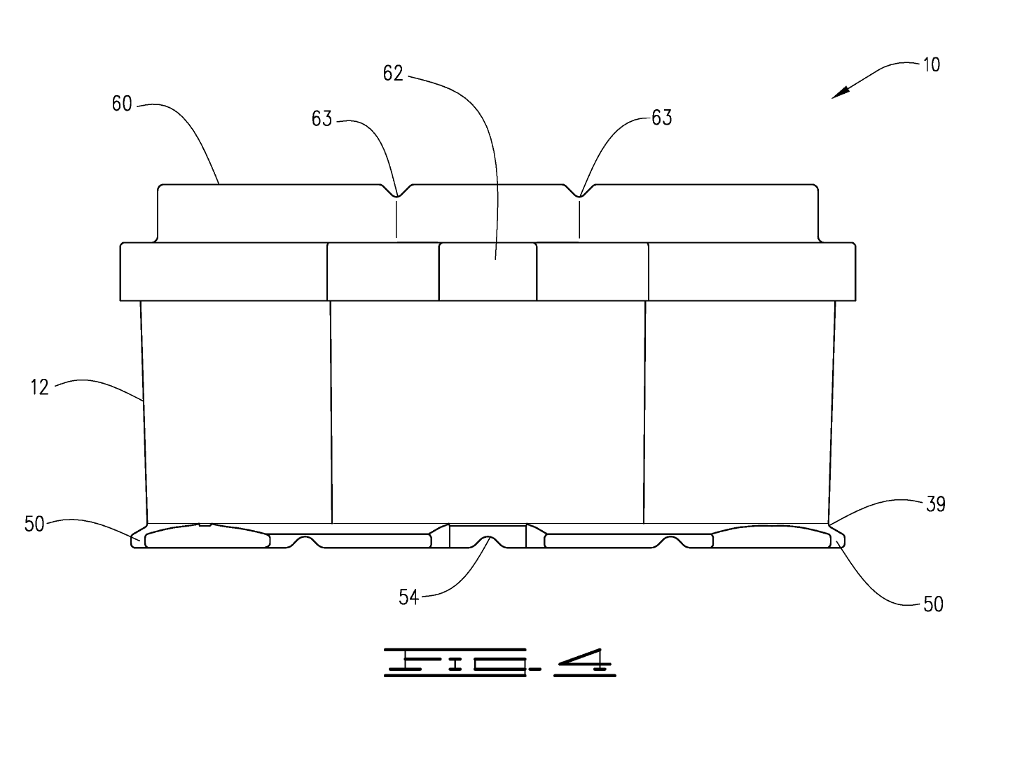

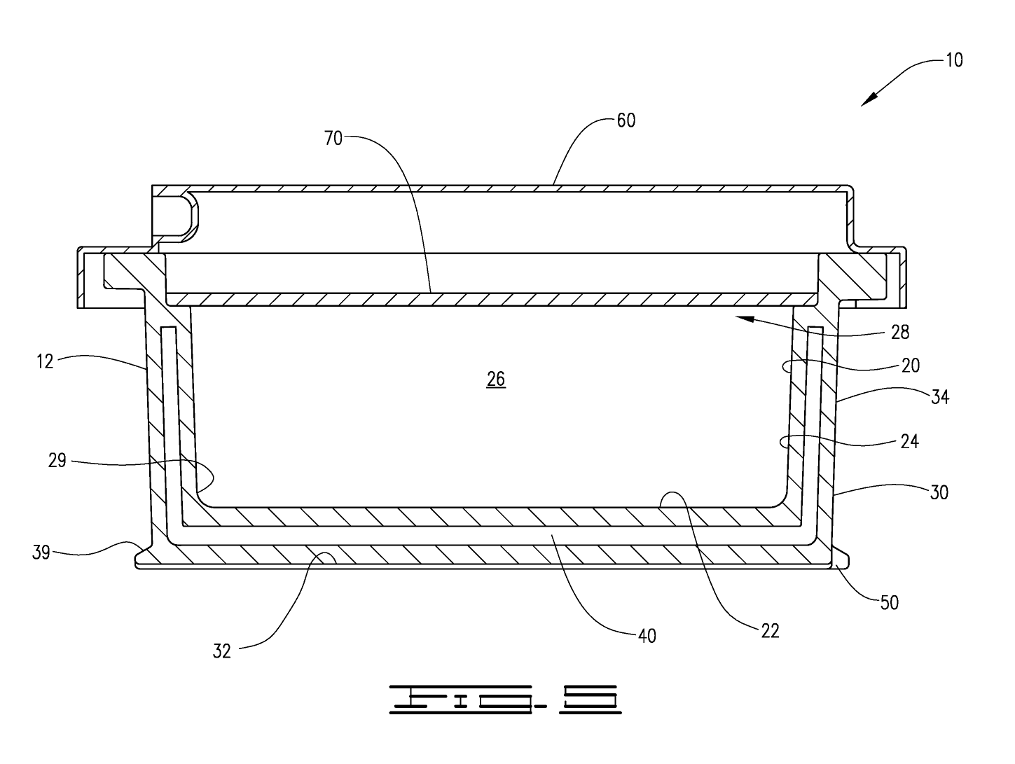

This disclosure concerns, among other things, catcher stations where the pig exits the pipeline and must be received, retained, trapped, or caught. FIGS. 1–6 show an apparatus for catching a pig after use in a pipeline in accordance with this disclosure. The pig catcher apparatus 10 generally comprises a vessel 12 having a double walled configuration with a lid 60 and a metal screen 70. This double wall configuration can best be seen from FIG. 5, where in vessel 12 has an inner wall 20 and an outer wall 30. Generally, inner wall 20 and outer wall 30 will be integrally molded together to form this double wall configuration. The inner wall 20, outer wall 30 and/or lid 60 can be manufactured of antistatic plastic material. In addition to the antistatic plastic or in replacement to, the vessel 12 and or lid 60 can be grounded so as to reduce static electric charge. In some applications, the inner wall 20, outer wall 30, and/or lid 60 can be manufactured of composites or polymers, such as static dissipative composites or polymers, or out of conductive composites or polymers.

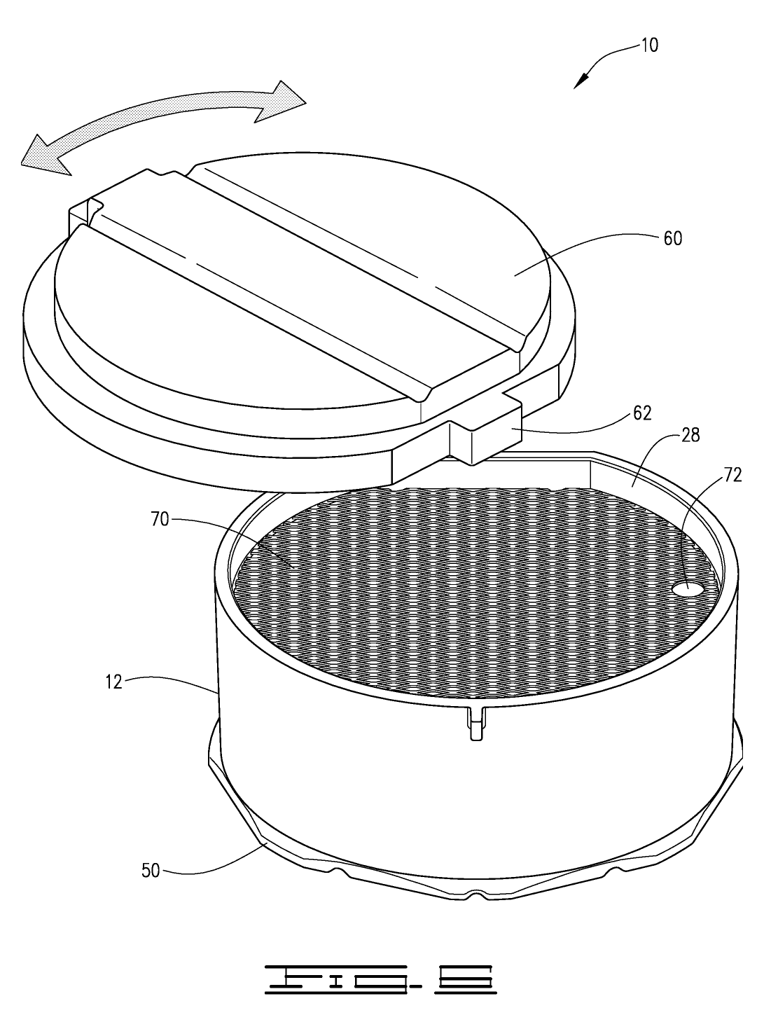

Inner wall 20 has an inner bottom portion 22 and an inner closed-wall portion 24 extending upward from inner bottom portion 22 so as to define a center chamber 26 terminating in an upper aperture 28 of the pig catcher vessel 12. Upper aperture 28 can best be seen from FIG. 6, which illustrates a perspective view of the pig catcher apparatus 10 comprising the vessel 12 having the lid 60 displaced from a first position covering the upper aperture 28 to a second position exposing the upper aperture 28. Inner bottom portion 22 and inner closed-wall portion 24 meet an inner edge 29.

The outer wall 30 has an outer bottom portion 32 and an outer closed-wall portion 34 extending upward from an outer bottom portion 32. The outer bottom portion 32 is typically flat. The outer bottom portion 32 and the outer closed-wall portion 34 meet at an outer edge 39. As will be understood from the figures, inner closed-wall portion 24 and outer closed-wall portion 34 are closed in that their circumference or outer perimeter is closed. That is, a cross-section of the inner closed-wall portion 24 or outer closed-wall portion 34 taken along a horizontal line would reveal a closed geometric shape to the relevant wall.

In some applications, inner wall 20 and outer wall 30 are configured in relation to one another so as to define an enclosed gap-chamber 40, that is space or chamber between the inner wall 20 and the outer wall 30 which does not have plastic material or other fill material in it. (Though in some applications the chamber can have a fill material in it, typically different than the material forming the walls.) Gap-chamber 40 surrounds at least the inner bottom portion 22 and at least partially surrounds inner closed-wall portion 24, though the gap-chamber 40 may have spacers or supports (not shown) therein to maintain the position of the two walls relative to each other. Generally, at the side walls, the width of gap-chamber 40 will be from about 2 to about 15 percent (or from about 5 to about 12 percent) of the width of the outer wall 30. Generally, under the inner bottom portion 22, the height of the gap-chamber 40 will be from about 2 to about 15 percent (or from about 5 to about 12 percent) of the height of the outer wall 30.

Referring now to FIGS. 1–4 and 6, a plurality of feet 50 are spaced around outer wall 30 at edge 39. The plurality of feet 50 are located along edge 39 so as to extend radially outwardly therefrom. Typically, the plurality of feet 50 are spaced apart so as to form the outward projection feet 50 alternating with areas without feet and only having edge 39. In the illustrated embodiment, the spaces are formed by arc feature 52 between the plurality of feet 50. It has been found that the plurality of feet 50, especially when integrally molded with the outer wall 30 at edge 39, make a more secure based for anchoring vessel 12 with less occurrence of the feet separating from the vessel 12.

Additionally, in embodiments, at least a portion of the plurality of feet 50 have a notch 54 therein configured to receive a bar, such as rebar, so as to prevent rotation and horizontal movement of the pig catcher apparatus 10.

The lid 60 of the pig catcher apparatus 10 is configured to cover the upper aperture 28 of the vessel 12. Lid 60 has an upper surface 62 which can have one or more V-drains 63 to channel rain and moister from the pig catcher apparatus 10. Typically, upper surface 62 will have at least two V-drains 63. Lid 60 can be attached to vessel 12 by a swivel hinge located at 64 and mounted on outer wall 30 of vessel 12. The swivel hinge 64 connects the cover to the vessel 12 and provides for lateral movement of the lid 60 with respect to vessel 12. Further, a latch 66 can be mounted on the outer wall 30 of the vessel 12 so as to oppose hinge 64. Latch 66 provides a means of securing the lid 60 closed. For example, but in no way limiting, the latch 66 can comprise a hub on the lid 60 and a tab on the vessel 12, which can be secured together by putting a lock or bolt through aligning apertures on the hub and lid.

As can be best seen by FIG. 6, the metal screen 70 of the pig catcher apparatus 10 extends across the upper aperture 28 of the vessel 12 such that the pipeline pig can be received, retained, supported, and/or caught on the metal screen 70 and fluids and small particulate matter can pass through the metal screen 70 into the center chamber 26. In some embodiments, the metal screen 70 defines a clean-out aperture 72 configured to allow the introduction of hoses used to clean out the center chamber 26. Metal screen 70 can be supported by braces or support bars (not shown) extending across the aperture 28 of the vessel 12 of the pig catcher apparatus 10.

The above-described embodiments can be used in a process for receiving, retaining, trapping, and/or catching a pipeline pig after use in a pipeline, wherein the pipeline has a catcher station from which a pipeline pig comes out of a pipeline. The process comprises placing the pig catcher apparatus 10 adjacent to the catcher station of a pipeline such that a pipeline pig coming out of the catcher station lands on the metal screen 70 of the pig catcher apparatus 10.

The placement of the pig catcher apparatus 10 can include burying at least a portion of the pig catcher vessel 12 such that the plurality of feet 50 are secured by dirt and/or concrete. Alternatively, or in addition to securing the plurality of feet 50 with dirt and/or concrete, the placement of the pig catcher apparatus 10 adjacent to the catcher station can include driving a plurality of bars (not shown) horizontally into the ground so that the each of the bars is received in a corresponding one of the notches of the plurality of feet 50 such that rotation and horizontal movement of the pig catcher apparatus 10, and therefore the vessel 12 of the pig catcher apparatus 10, is prevented.

After placement, the process includes catching the pipeline pig coming out of the catcher station on the metal screen 70 of the pig catcher apparatus 10 and allowing fluids and/or small particulate matter to pass through the screen into the center chamber 26. Afterwards, the pig can be retrieved from the pig catcher apparatus 10.

Further, the process can include cleaning fluids and/or small particulate matter out the center chamber using a vacuum hose after the step of allowing fluids and/or small particles to pass through the metal screen 70. The cleaning out can be done by introducing a vacuum hose into the clean-out aperture 72 of the metal screen 70 so that the hose accesses the center chamber 26.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

Therefore, the present systems and methods are well adapted to attain the ends and advantages mentioned, as well as those inherent therein. Any examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A process for catching a pipeline pig after use in a pipeline having a catcher station from which a pipeline pig comes out of a pipeline, the process comprising:
placing a pig catcher apparatus adjacent to the catcher station of a pipeline such that the pipeline pig coming out of the catcher station lands on the pig catcher apparatus, the pig catcher apparatus comprising:
a vessel having a double wall configuration including:
an inner wall having an inner bottom portion and an inner closed-wall portion extending upward from the inner bottom portion so as to define a center chamber terminating in an upper aperture; and
an outer wall having an outer bottom portion and an outer closed-wall portion extending upward from the outer bottom portion, wherein the outer bottom portion is flat, and the outer bottom potion and the outer closed-wall portion meet at an outer edge, wherein the inner wall and outer wall are configured so as to define an enclosed gap-chamber such that the gap-chamber surrounds at least the inner bottom portion and inner closed-wall portion;
a metal screen extending across the upper aperture such that the pipeline pig can be supported on the metal screen and fluids and small particulate matter can pass through the screen into the center chamber; and
a plurality of feet integrally molded with the outer wall, wherein the plurality of feet are located along the outer edge of the outer wall so as to extend outwardly therefrom and are spaced apart;
burying at least a portion of the vessel such that the plurality of feet are secured by dirt and/or concrete,
catching the pipeline pig coming out of the catcher station on the metal screen of the pig catcher apparatus; and
allowing fluids and small particulate matter to pass through the metal screen into the center chamber.

2. The process according to claim 1, further comprising cleaning out the center chamber using a vacuum hose after the step of allowing fluids and small particles to pass through the screen, wherein the metal screen defines a clean-out aperture configured to allow the introduction of the vacuum hose into the center chamber.

3. The process according to claim 1, wherein the outer wall and inner wall of the pig catcher vessel of the pig catcher apparatus are made from an anti-static plastic.

4. The process according to claim 1, further comprising grounding the pig catcher vessel and/or lid.

5. The process according to claim 1, wherein at least a portion of the plurality of feet have a notch, and wherein the placing the pig catcher apparatus adjacent to the catcher station comprises driving a plurality of bars horizontally into the ground so that the each of the bars is received in a corresponding one of the notches such that rotation and horizontal movement of the pig catcher vessel is prevented.

6. The process according to claim 5, further comprising grounding the pig catcher vessel and/or lid.

7. The process according to claim 5, further comprising cleaning out the center chamber using a vacuum hose after the step of allowing fluids and small particles to pass through the metal screen, wherein the metal screen defines a clean-out aperture configured to allow the introduction of the vacuum hose into the center chamber.

8. The process according to claim 1, wherein the pig catcher apparatus further comprises:
a lid configured to cover the upper aperture, wherein the lid has an upper surface defining at least two V-drains;
a swivel hinge mounted on the outer wall of the vessel, wherein the swivel hinge connects the lid to the vessel; and
a latch mounted on the outer wall of the vessel so as to oppose the hinge.

9. A process for catching a pipeline pig after use in a pipeline having a catcher station from which a pipeline pig comes out of a pipeline, the process comprising:
placing a pig catcher apparatus adjacent to the catcher station of a pipeline such that a pipeline pig coming out of the catcher station lands on the pig catcher apparatus, the pig catcher apparatus comprising:
a double wall configuration including:
an inner wall having an inner bottom portion and an inner closed-wall portion extending upward from the inner bottom portion so as to define a center chamber terminating in an upper aperture; and
an outer wall having an outer bottom portion and an outer closed-wall portion extending upward from the outer bottom portion, wherein the outer bottom portion is flat, and the outer bottom potion and the outer closed-wall portion meet at an outer edge, wherein the inner wall and outer wall are configured so as to define an enclosed gap-chamber such that the gap-chamber surrounds at least the inner bottom portion and inner closed-wall portion; and
a metal screen extending across the upper aperture such that the pipeline pig can be supported on the metal screen and fluids and small particulate matter can pass through the screen into the center chamber; and
a plurality of feet integrally molded with the outer wall, wherein the plurality of feet are located along the outer edge so as to extend outwardly therefrom and are spaced apart, wherein at least a portion of the plurality of feet have a notch, wherein placing the pig catcher apparatus adjacent to the catcher station further comprises driving a plurality of bars horizontally into the ground such that the each of the bars is received in a corresponding one of the notches such that rotation and horizontal movement of the pig catcher vessel is prevented;
catching the pipeline pig coming out of the catcher station on the metal screen of the pig catcher apparatus; and
allowing fluids and small particulate matter to pass through the metal screen into the center chamber.

10. The process according to claim 9, further comprising cleaning out the center chamber using one or more vacuum hoses after the step of allowing fluids and small particles to pass through the metal screen, wherein the metal screen defines a clean-out aperture configured to allow the introduction of the one or more vacuum hoses into the center chamber.

11. The process according to claim 9, wherein placing the pig catcher apparatus adjacent to the catcher station comprises burying at least a portion of the pig catcher vessel such that the feet are secured by dirt and/or concrete.

12. The process according to claim 9, wherein the outer wall and inner wall of the pig catcher vessel of the pig catcher apparatus are made from an anti-static plastic.

13. The process according to claim 9, further comprising grounding the pig catcher apparatus.

14. The process according to claim 9, wherein the pig catcher apparatus further comprises:
a lid configured to cover the upper aperture of the vessel, wherein the lid has an upper surface defining at least two V-drains;
a swivel hinge mounted on the outer wall of the vessel, wherein the swivel hinge connects the lid to the vessel; and
a latch mounted on the outer wall of the vessel so as to oppose the hinge.

15. A pig catcher apparatus for receiving a pipeline pig after use in a pipeline, the pig catcher apparatus, comprising:
a vessel having a double wall configuration including:
an inner wall having an inner bottom portion and an inner closed-wall portion extending upward from the inner bottom portion so as to define a center chamber terminating in an upper aperture; and
an outer wall having an outer bottom portion and an outer closed-wall portion extending upward from the outer bottom portion, wherein the outer bottom portion is flat, and the outer bottom potion and the outer closed-wall portion meet at an outer edge, wherein the inner wall and outer wall are configured so as to define an enclosed gap-chamber such that the gap-chamber surrounds at least the inner bottom portion and inner closed-wall portion;
a metal screen extending across the upper aperture such that the pipeline pig can be supported on the metal screen and fluids and small particulate matter can pass through the metal screen into the center chamber, wherein the metal screen defines a clean out aperture configured to allow the introduction of one or more hoses and used to clean out the center chamber; and
a plurality of feet integrally molded with the outer wall, wherein the plurality of feet are located along the outer edge so as to extend outwardly therefrom and are spaced apart, wherein at least a portion of the plurality of feet have a notch therein configured to receive a bar so as to prevent rotation and horizontal movement of the pig catcher vessel of the pig catcher apparatus.

16. The pig catcher apparatus according to claim 15, wherein the outer wall and inner wall of the pig catcher vessel of the pig catcher apparatus are made from an anti-static plastic.

17. The pig catcher apparatus according to claim 15, wherein the pig catcher apparatus is grounded.

18. The pig catcher apparatus according to claim 15, further comprising:
a lid configured to cover the upper aperture, wherein the lid has an upper surface defining at least two V-drains;
a swivel hinge mounted on the outer wall of the vessel, wherein the swivel hinge connects the lid to the vessel; and
a latch mounted on the outer wall of the vessel so as to oppose the hinge.

19. The pig catcher apparatus according to claim 18, wherein the outer wall and inner wall of the pig catcher vessel of the pig catcher apparatus are made from an anti-static plastic.

20. The pig catcher apparatus according to claim 18, wherein the pig catcher apparatus is grounded.
